(19) United States
(12) Patent Application Publication
(10) Pub. No.: US 2015/0194848 A1
(43) Pub. Date: Jul. 9, 2015

(54) MOTOR WITH A PLURALITY OF PERMANENT MAGENETS AT EACH STATOR POLE

(71) Applicant: BLACK & DECKER INC., Newark, DE (US)

(72) Inventors: Stephen P. Osborne, Pikesville, MD (US); Colin M. Crosby, Baltimore, MD (US)

(73) Assignee: BLACK & DECKER INC., Newark, DE (US)

(21) Appl. No.: 14/661,258

(22) Filed: Mar. 18, 2015

Related U.S. Application Data
(63) Continuation of application No. 13/112,136, filed on May 20, 2011.

(51) Int. Cl. H02K 1/18; H02K 1/17

(52) U.S. Cl. CPC H02K 1/185; H02K 1/17

(57) ABSTRACT

A permanent magnet electric motor has a stator and a rotor. The stator includes a stator housing with at least a North pole and a South pole, each pole including permanent magnets of the same polarity including two outer magnets arranged at pole tips and at least one inner magnet disposed therebetween. The outer magnets have greater thickness than the inner magnet to provide higher demagnetization resistance than the at least one inner magnet within each pole. The magnets are affixed to an inner surface of the stator housing, and the inner surface of the stator housing include a projected surface within each pole to which the inner magnet is affixed so that surfaces of the inner and outer magnets facing a center of the stator housing are arranged at a same distance from the center of the stator housing.

### CROSS-REFERENCE TO RELATED APPLICATIONS

This application is a Continuation of Ser. No. 13/112,136 filed May 20, 2011, the entire contents of which is incorporated herein by reference in its entirety.

### FIELD

This disclosure relates to arrangement of magnets in the stator of electric motors, particularly for power tools.

### BACKGROUND

Today, rare earth magnets are the strongest type of permanent magnets available. The magnetic field typically produced by rare earth magnets can be in excess of 11 teslas, whereas by comparison the magnetic field produced by conventional ferrite or ceramic magnets is in the magnitude of 0.5 to 1 tesla. For this reason, the use of rare earth magnets has substantially increased in applications requiring powerful magnets, including, but not limited to, computer hard drives, audio speakers, self-powered flashlights, etc. One particular area where rare earth magnets have been heavily utilized is in the motors of corded and cordless power tools, where high magnetism of rare earth magnets is suitable for high-power applications.

As demand for rare earth magnets have increased, rare earth materials such as terbium and dysprosium have become more expensive. It is thus important to utilize rare earth magnet in a cost-effective matter.

### SUMMARY

Magnets in motors should have differing characteristics based on their position in the magnetic circuit. In many cases, all magnets in the motor are chosen to be the same to simplify construction and procurement. There are advantages, however, to selecting optimum magnetic material based on the magnets position in the magnetic circuit. By optimizing the magnet's placement and properties, cost and performance synergies can be realized.

A power tool is provided including a housing, a permanent magnet electric motor in the housing, and an output member coupled to the electric motor. The electric motor includes a rotor and a stator, the stator having a stator housing with at least a North pole and a South pole. Each pole of the stator housing includes permanent magnets affixed to an inner surface of the stator housing, where at least two of the permanent magnets have dissimilar characteristics.

According to an aspect, at least two of the permanent magnets within each pole have different thickness levels. For example, the permanent magnets arranged at the pole tips may be thicker than permanent magnets arranged in the middle portion of the pole. The permanent magnets arranged at the pole tips and the magnets arranged in the middle portion of the may be of similar or different magnetic material.

According to an embodiment, the stator housing is recessed to accommodate the magnets within each pole. The recess of the stator housing may include a projection portion to accommodate the thinner magnets, such that the inner surfaces of the permanent magnets facing the center of the stator housing are at a same distance from the center of the stator housing.

According to a different aspect, at least two of the magnets within each pole have dissimilar compositions of magnetic material yielding dissimilar grades of demagnetization resistance. For example, magnets arranged at pole tips may be made of material having a higher grade of demagnetization resistance than magnets arranged in a middle portion of the pole. In an exemplary embodiment, the pole magnets may include neodymium (Nd) and more than 4% of dysprosium (Dy) and/or terbium (Tb), and middle magnets may include neodymium (Nd) and between 0% to 4% of dysprosium (Dy) and/or terbium (Tb).

The middle magnets and the pole magnets may be of similar or different widths. In an embodiment, the middle magnets are provided with greater thickness. The recess portion of the stator housing accommodating the magnets may be further recesses to accommodate the thicker magnets such that the inner surfaces of the permanent magnets facing the center of the stator housing are at a same distance from the center of the stator housing.

According to an embodiment, in order to better distinguish the magnets of different grades, magnets have dissimilar shapes, sizes, magnetization levels, color plating, or color coating may be provided. The permanent magnets may be flat in some embodiments and arcuate in other embodiments.

According to an embodiment, the permanent magnets include rare earth magnetic material, non-rare earth material, or a combination thereof. For example, magnets arranged at the pole tips may be flat magnets including rare-earth magnetic material, and at least one magnet arranged between the pole tips may be arcuate and include non-rare-earth magnetic material.

According to an aspect, instead of providing magnets of different widths, magnets of similar widths may be provided and two or more of the magnets may be stacked on top of each other at the pole tips.

### BRIEF DESCRIPTION OF THE DRAWINGS

The drawings described herein are for illustration purposes only and are not intended to limit the scope of this disclosure in any way.

The drawings described herein are for illustration purposes only and are not intended to limit the scope of this disclosure in any way.

FIG. 1 is a schematic of a process for making arced magnets in accordance with an aspect of this disclosure;

FIG. 2A is a prior art stator assembly for a PMDC motor having 4 NdFeB arced magnets with 2 magnets forming the north pole and two magnets forming the south pole;

FIG. 2B is a stator assembly for a PMDC motor having 4 arced magnets having the same IR and OR with 2 magnets forming the North pole and two magnets forming the South pole.

FIG. 3 is an end view of a stator assembly for a PMDC motor having 2 planar magnet segments in accordance with an aspect of this disclosure;

FIG. 4 is an end view of a stator assembly for a PMDC motor having 3 planar magnet segments in accordance with an aspect of this disclosure;

FIG. 5 is a perspective view of a stator assembly for a PMDC motor having flat magnets affixed to flat sections of a stator housing;

FIGS. 6A and 6B are schematics comparing a PMDC motor in accordance with an aspect of this disclosure having a larger number of small magnet segments with a prior art PMDC motor having fewer, larger magnet segments;

FIG. 7 is an end view of a stator assembly for a PMDC motor having planar magnet segments attached to an arcuate inner surface of a stator housing with glue filling the gaps between radial outer surfaces of the magnet segments and the arcuate inner surface of the stator housing, in accordance with an aspect of this disclosure;

FIG. 8 is perspective view of a stator assembly for a PMDC motor having five planar magnets per pole attached to flat sections of a stator housing;

FIG. 9 is a schematic showing a sequence of insertion of magnets into a stator housing in accordance with an aspect of this disclosure;

FIG. 10 is a schematic view of fixturing of magnets during the insertion sequence of FIG. 9;

FIG. 11 is a schematic view of a pre-assembly of magnets in an alternating magnetic polarity configuration in accordance with an aspect of this disclosure;

FIG. 12 is a side view of a section of a stator housing having the pre-assembly of magnets of FIG. 11 inserted therein;

FIG. 13 is a schematic view of a pre-assembly of magnets with unmagnetized magnets disposed between magnetized magnets in accordance with an aspect of this disclosure;

FIG. 14 is a side view of a section of a stator housing in which the magnets of a pole are unevenly disposed about the pole in accordance with an aspect of this disclosure;

FIG. 15A is a side view of a section of a stator housing in which at least one magnet of a pole is thinner than other magnets of the pole in accordance with an aspect of this disclosure;

FIG. 15B is a side view of a section of a stator housing in which magnets of similar width are stacked at the pole tips in accordance with an aspect of this disclosure;

FIG. 15C is a side view of a section of a stator housing in which the stator housing includes a recess and a projected surface within the recess to keep the inner surfaces of the magnets in alignment;

FIG. 16A is a side view of a section of a stator housing in which at least one magnet of a pole has a different grade of demagnetization resistance than other magnets of the pole in accordance with an aspect of this disclosure;

FIG. 16B is a side view of a section of a stator housing in which magnets with different grades of demagnetization resistance have different widths;

FIG. 17 is a side view of a section of a stator housing in which two high grade magnets provided at pole tips are overmolded with magnetic material of different magnetic grade;

FIG. 18A is a side view of a section of a stator housing in which a single layer of overmold material is provided with greater thickness at the pole tips;

FIG. 18B is a side view of a section of a stator housing in which a pair of magnets are provided at pole tips and a layer of overmold material provided over the entire pole including the pair of magnets;

FIG. 19 is a side view of a section of a stator housing in which a pair of magnets are provided at pole tips with a magnet of different grade provided therebetween;

FIG. 20 is a side perspective view of a prior art power tool.

### DETAILED DESCRIPTION

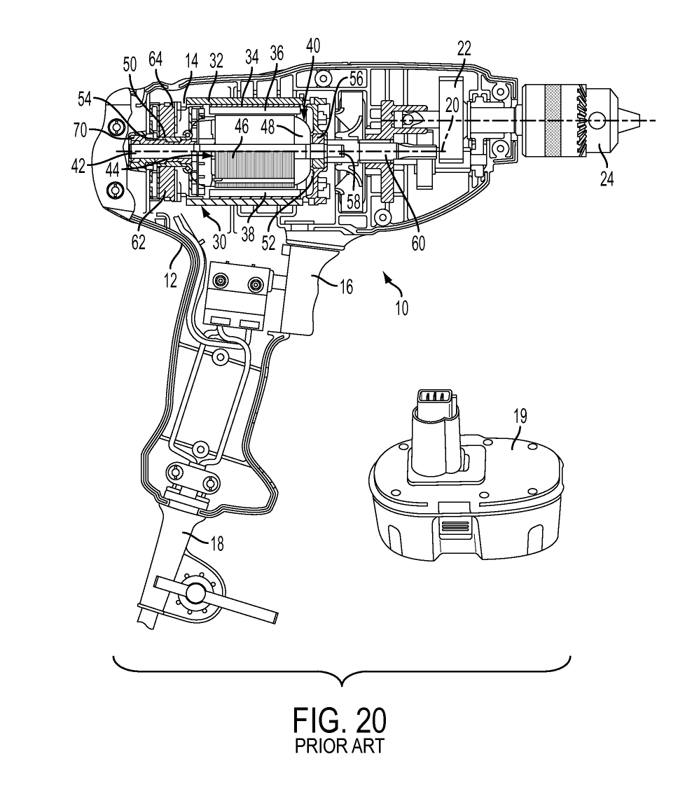

Referring now to FIG. 20, a prior art power tool 10 is shown. The power tool 10 includes a housing 12 which surrounds a motor 14. An activation member 16 is coupled with the motor and a power source 18. The power source 18 includes either a power cord (AC current) or includes a battery pack 19 (DC current). The motor 14 is coupled with an output member 20 that includes a transmission 22 and a chuck 24. The chuck 24 is operable to retain a tool (not shown).

The motor includes a stator assembly 30. The stator assembly 30 includes a stator housing 32, a flux ring 34 and magnets 36. The flux ring 34 is an expandable or split flux ring. An armature 40 includes a shaft 42, a rotor 44 and a commutator 50 coupled with the shaft 42. The rotor 44 includes laminations 46 and windings 48. The motor 14 also includes end plates 52 and 54. End plate 52 includes a front bearing 56 which supports one end of a shaft 42. The shaft 42 is coupled with a pinion 60 that is part of the output member 20. Brushes 62 and 64 are associated with the commutator 50. A rear bearing 70 is also coupled with the end plate 54 to balance rotation of the shaft 42.

While motor 14 is illustratively shown as a permanent magnet DC (“PMDC”) motor in which magnets 36 are affixed to an inner surface of flux ring 34, it should be understood that motor 14 could be other types of motors that utilize permanent magnets, such as a brushless motor in which the rotor has permanent magnets and the stator has electronically commutated windings. The power tool 10 is illustrated as a drill, however, any type of power tool may be used in accordance with this invention. The power tool 10 includes a housing 12 which surrounds a motor 14. An activation member 16 is coupled with the motor and a power source 18. The power source 18 includes either a power cord (AC current) or includes a battery (DC current) (not shown). The motor 14 is coupled with an output member 20 that includes a transmission 22 and a chuck 24. The chuck 24 is operable to retain a tool (not shown).

The motor includes a stator assembly 30. The stator assembly 30 includes a stator housing 32, a flux ring 34 and magnets 36. The flux ring 34 is an expandable or split flux ring. An armature 40 includes a shaft 42, a rotor 44 and a commutator 50 coupled with the shaft 42. The rotor 44 includes laminations 46 and windings 48. The motor 14 also includes end plates 52 and 54. End plate 52 includes a front bearing 56 which supports one end of a shaft 42. The shaft 42 is coupled with a pinion 60 that is part of the output member 20. Brushes 62 and 64 are associated with the commutator 50. A rear bearing 70 is also coupled with the end plate 54 to balance rotation of the shaft 42.

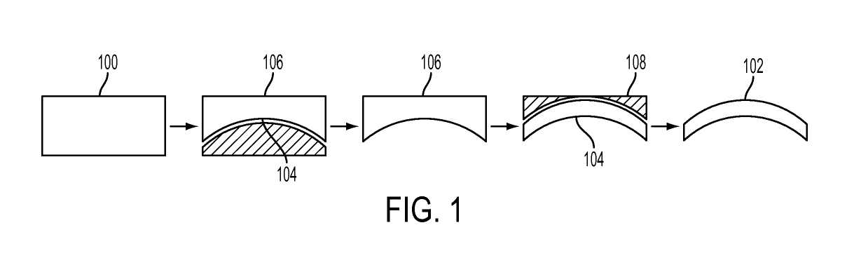

Referring to FIG. 1, a process for making arced magnets with the “same” OR and IR is described. The arced magnets are illustratively used in an electric motor of a power tool, such as in an electric motor used in lieu of motor 14 of power tool 10. In accordance with this process, the OR and IR of the arced magnets are essentially the same, with only a small offset as a result of the manufacturing process of hole sawing or EDM—the kerf of the EDM wire or hole saw results in the small difference after cutting. In such a process, the OR can be made to the desired size when the magnet is to be aligned or glued to the ID of a motor can, such as to the ID of a stator housing or flux ring in a permanent magnet DC motor for example. And the IR can be controlled to the desired dimension in the case where the magnet is attached to a rotor, such as to a rotor in a brushless motor for example. By designing the magnetic circuit appropriately (magnet thickness and magnetic air gap) the magnet grinding process can be eliminated, resulting in lower magnet production costs by reducing material scrap and elimination of the need for a grinding machine and operation. The tolerances produced by the hole sawing or EDM are sufficiently small and suitable for application in power tool motors. The main difference is that the magnet thickness is no longer constant over the arc of the magnet. It will be thicker at the center and thinner at the edges of the magnet. As long as the magnet circuit is designed to accommodate this, the motor performance objectives can be met. Additionally, this will have the added benefit of reduced cogging torques since the magnetic air gap is larger at the leading and trailing edges of the magnets.

For purposes of this application, magnetic air gap is the space between the surface of the laminations of the rotor or stator and the facing surface of the magnets of the other of the rotor or stator. For example, if the motor is PMDC motor where the stator has permanent magnets affixed to an inner surface of a stator housing and the rotor has magnetic wires wound in slots of a lamination stack on a shaft of the rotor, the magnetic air gap is the space between radially inner surfaces of the permanent magnets affixed to the inner surface of the stator housing and the outer surface of the lamination stack of the rotor.

The process in FIG. 1 proceeds left to right across FIG. 1. Starting with block of magnet material 100, the block 100 of magnet material is machined, such as by sawing or EDM, to form the IR 104 of an arcuate magnet segment 102. The magnet segment 102 may illustratively be used for a rotor of an electric motor. It may also be used for a stator of an electric motor. When the magnet segment 102 is used for a rotor, the IR is illustratively cut slightly smaller than the OR of the rotor back iron to provide for a glue gap.

After the IR is machined, the processed magnet block identified with reference number 106, is then machined to form the OR 108 of magnet segment 102 so that the OR is essentially the same as the IR.

In accordance with another aspect of this disclosure, magnets, illustratively NdFeB magnets, are made by cutting blocks of magnetic material, such as blocks of NdFeB, into flat, planar segments. Such segments are commonly used in interior permanent magnet (IPM) brushless motor rotors. However they can also be used in brushed permanent magnet DC (PMDC) motors if designed appropriately.

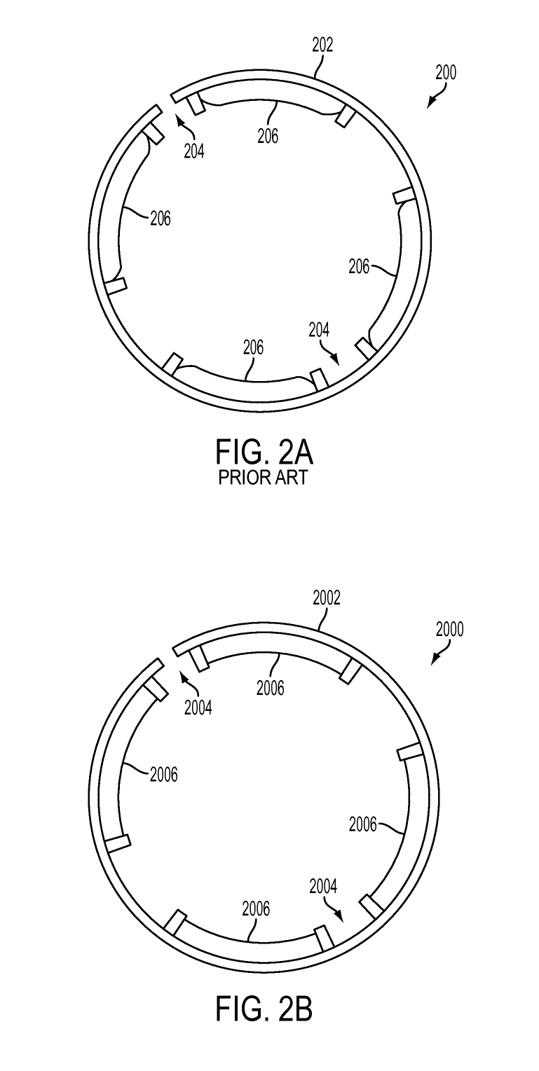

FIG. 2A shows a prior art stator assembly 200 having a stator housing 202 (it being understood that a flux ring could also be used) for a PMDC motor having conventional two magnet arcs 204, 204, each comprising a North or South pole. In PMDC motors presently made by Black & Decker Inc., four NdFeB arcuate magnets 206 are used with two magnets 206 forming the North pole and two magnets forming the South pole.

FIG. 2B shows a stator assembly 2000 in accordance with an aspect of this disclosure having a stator housing 2002 (it being understood that a flux ring could also be used) for a PMDC motor having two magnet arcs 2004, each comprising a North or South pole. Illustratively, two magnets 2006 form each of the North and South poles. In this aspect, the magnets 2006 have essentially the same IR and OR. In this regard, magnets 2006 may illustratively be made in accordance with the process described with respect to FIG. 1.

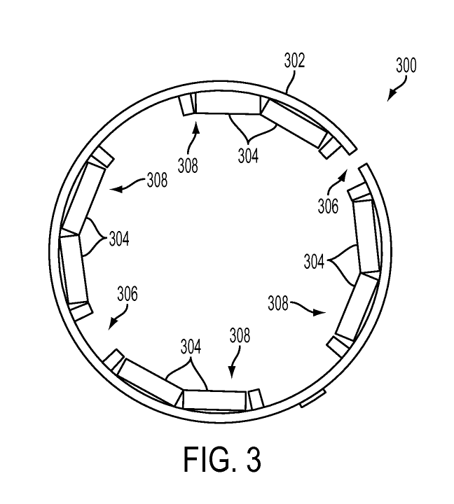

In accordance with an aspect of this disclosure, for flat magnets, it may be possible to still use two flat magnets per pole (or pole half where two sets of magnets form each pole), or it may be more advantageous to use three or more flat magnets per pole (or partial pole) to make the mechanical geometry as well as the magnetic circuit design of the magnet can assembly more practical. FIG. 3 is an end view showing a stator assembly 300 in accordance with an aspect of this disclosure for a PMDC motor having a stator housing 302 with two segments 308 per pole 306. Each segment 308 has two flat magnets 304. In FIG. 3, the magnetic air gap at the ends of each flat magnet 304 is greater than at the center of each flat magnet 304.

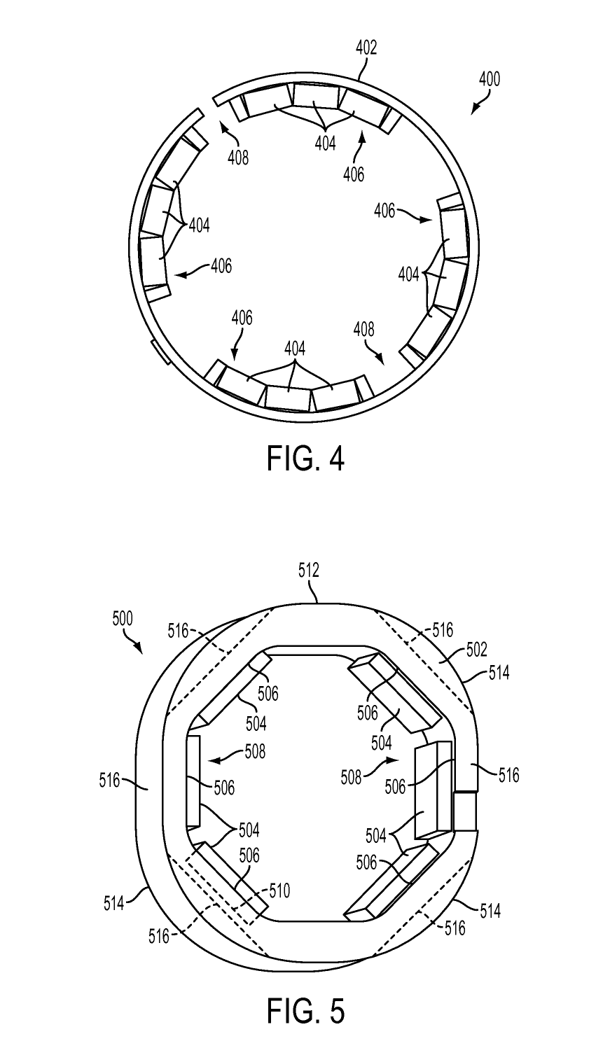

FIG. 4 is an end view showing a stator assembly 400 in accordance with an aspect of this disclosure for a PMDC having a stator housing 402 with 3 flat magnets 404 per partial pole 406. Each pole 408 in the embodiment shown in FIG. 4 has two partial poles 406. It should be understood that each pole 408 could be formed by three or more sets of two or more flat magnets 404. It should also be understood that the PMDC motor could have a plurality of north and south poles 408.

In an aspect of this disclosure, saws are used to slice the larger blocks of magnet material into the thinner, flat magnets for use in the motor. Again, this eliminates the grinding process and also has a faster processing time compared to hole sawing and EDM used for arced magnets as described. Thus, the flat magnets would be even less expensive to produce.

It should be noted that the flat magnets could be used in conjunction with the anchoring system currently being used with overmolded stator assemblies, such as described in the above referenced U.S. Pat. Nos. 6,522,042, 7,088,024 and 6,983,529. In this case, it may be more advantageous to use 3 flat magnets since doing so would allow the plastic overmolding wall thickness to be reduced compared to using 2 flat magnets, as well as minimize the changes to the magnetic air gap and magnet.

Additionally flat magnets can be used in a glued stator assembly with the flat magnet(s) glued to a mating planar or arcuate portion(s) of a stator housing or motor can (or flux ring). FIG. 5 is a perspective view of a stator assembly 500 for a PMDC motor in accordance with an aspect of this disclosure having a stator housing 502. Stator housing 502 has flat magnets 504 attached to flat sections 506 (which may also be referred to as flats) of the stator housing 502. Stator assembly 500 illustratively has two poles 508 (one North pole and one South pole). In this aspect, the magnetic air gap is larger at the edges of the magnet, so it can be expected to reduce the cogging torque of the motor, though the magnetic circuit needs designed appropriately to meet the motor performance requirements. In an aspect, the magnetic air gap is illustratively at least twenty-five percent (25%) greater at the edges of the magnet than at the center of the magnet. In an aspect, the magnetic air gap is illustratively at least fifty percent (50%) greater at the edges of the magnet than at the center of the magnet.

FIG. 7 is a perspective view of a stator assembly 700 for a PMDC motor in accordance with an aspect of this disclosure having a stator housing 702. Stator housing 702 has flat magnets 704 attached to an arcuate inner surface 706 of a stator housing 702 with glue 708 filling the gap between a radially outer surface 710 of the flat magnet 704 and the arcuate inner surface 706 of the stator housing 702.

In assembling the flat magnets to the stator housing, it is possible to use glue, or it is possible to use a double sided adhesive tape/foam that is sufficiently thin so that the magnet is not significantly spaced away from the stator housing back iron. Further, it may be possible to position the flat magnets within flat pockets on the inside of the stator housing (one such flat pocket 510 is shown in phantom in FIG. 5), thus eliminating the need for expensive and hard to maintain glue fixtures.

In the aspect shown in FIG. 5 where flat magnets 504 are attached to flat sections 506 of the stator housing 502, the thickness of the stator housing 502 (and thus the amount of steel), particularly at the center of the flat magnets 504, is greater than in the aspect of FIG. 7 where the stator housing 702 has an arcuate inner surface 702 and the flat magnets 704 are attached to the arcuate inner surface 702. And in particular, this is the case where, such as for an aspect of FIG. 5, an outer surface 512 of the stator housing 502 is arcuate (in whole or in part) and does not have flats corresponding to all or some of the flat sections 506 (which may be disposed in an arcuate inner surface of stator housing 502). In the embodiment of FIG. 5, outer surface 512 of stator housing 502 is arcuate at 514 adjacent the outer two flat magnets 504 of each set of three flat magnets 504 and flat at 516 adjacent the center flat magnet 504 of each set of three flat magnets 504. This increased amount of steel increases the flux path which increases the flux density of the magnetic circuit through the armature. This reduces flux leakage, which decreases the magnetic attraction of foreign objects to the housing. It should be understood, however, that in an aspect outer surface 512 of stator housing 502 can have flats corresponding to each flat section 506, the additional flats shown in phantom at 516 in FIG. 5.

In making the stator housing for 2-pole, 4-pole, or higher pole count motors, it may be possible to make it by stamping and rolling, or by cold drawing the stator housing the drawn-over-mandrel (DOM) process. The DOM is followed by sawing the tubing to length and finishing the ends of the stator housing as required, if required. If the stator housing is made by the DOM process, the stator housing may also have the design features of the outer surface of the stator housing being round with the inside surface being a combination of round and flat spots where the flat magnets are to be placed. Thus, the wall thickness of the stator housing is not uniform, and must be designed accordingly for the required magnetic circuit.

The outer surface wall of the stator housing can have flats, such as flats 516 shown in FIG. 5 corresponding to the flat sections (such as flat sections 506 shown in FIG. 5) on the inner surface of the stator housing for magnet placement. These flats on the outside of the stator housing can further be used to accurately locate the stator assembly within the motor pack or power tool housing (two alternate methods of forming a power tool motor). This is required for correct angular positioning of the magnets relative to the motor brushes. In the case of a non-motor pack design, the flats on the outside of the stator housing may be used to key out the stator assembly within the power tool. Ideally this is done visibly, i.e., not a blind assembly process.

The thickness of the stator housing could be thinner over the pole centers to reduce the weight of the steel used in the stator housing, also as shown in FIG. 5. Again, this steel may be removed with minimal effect on the magnetic circuit, and must be designed accordingly to meet the motor performance requirements.

In the case of a stamped stator housing, it could be possible to coin the thickness of the metal prior to rolling the stator housing resulting in similar thinner wall stator housings.

Finally, the stator housing may be made by laminations, magnetic powder metal/insulated powder metal, or metal injection molding.

The foregoing aspects of the disclosure provide a number of advantages, which include: simplified & thus lower cost magnet production, and reduced cogging torque in the motor; making it possible to adhere the flat magnets to the stator housing double sided adhesive, eliminating need for fixtures and a difficult to control process; making it possible to use multiple flat magnet segments to replace a single arc segment; and the stator housing may contain features to locate the stator assembly within a power tool or motor pack.

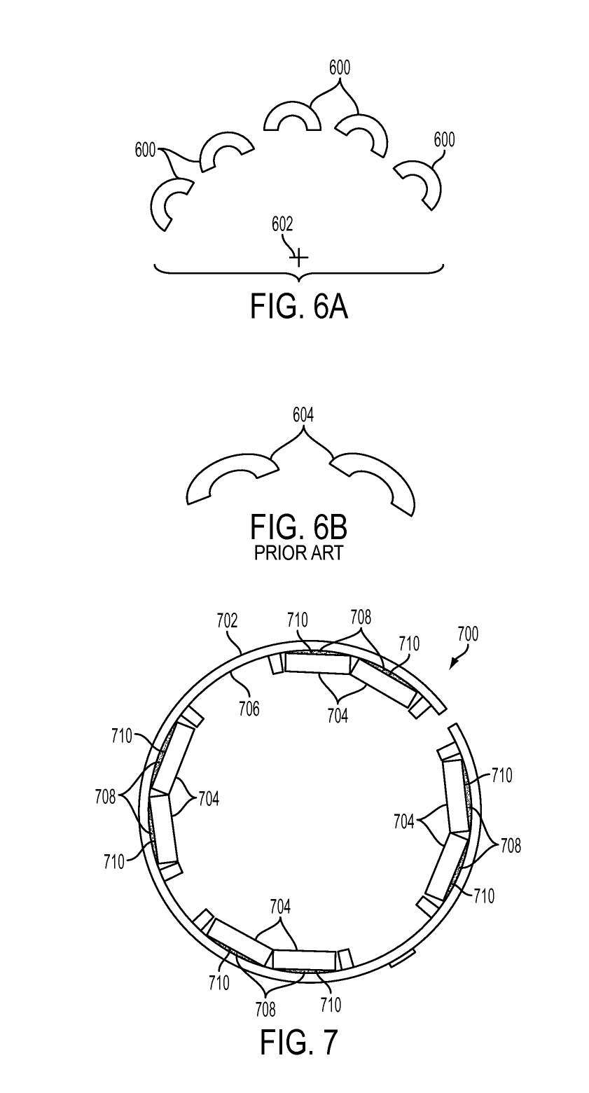

In accordance with another aspect of this disclosure, with reference to FIG. 6A, a larger number of smaller discrete, anisotropic magnets (arcuate or flat in shape) provide for a more radial magnet field than having two discrete, anisotropic magnets per pole. For example, having 5 small, sintered anisotropic NdFeB magnets 600 to form each pole will have 5 directions of linearly oriented magnetization pointing to the ID center point 602 of the stator housing (not shown in FIG. 6A). This is compared to two directions of linearly oriented magnetization pointing to the ID center point of the stator housing when two magnets 604 are used to form each pole, as shown in FIG. 6B. Radial magnetization means that the magnetic field through the magnet is pointing radially towards the center point of the ID of the stator housing. However in making sintered NdFeB magnets the magnet is linearly oriented during the manufacturing process, and thus magnetically anisotropic. Thus when magnetized in the motor, the linear bias remains and the magnetic field direction remains linear in the stator housing. By using more, smaller magnets, such as 5, the field becomes more radial as shown in FIG. 6A, as compared to using fewer, larger segments, such as 2, as shown in FIG. 6B.

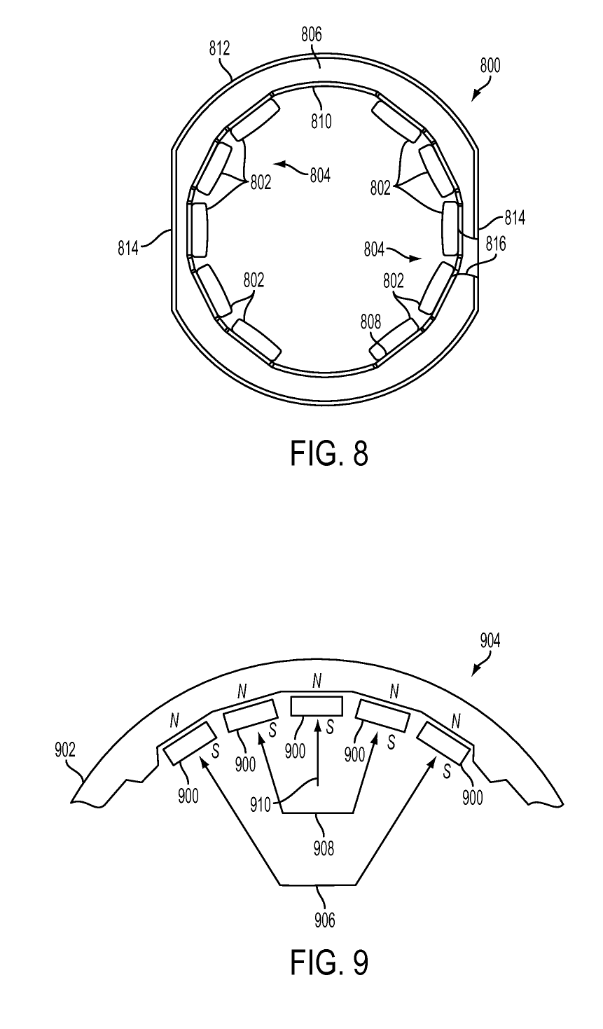

FIG. 8 shows an aspect in which a stator assembly 800 for a PMDC motor has five smaller flat magnets 802 for each of the poles 804 (north and south poles). Stator housing 806 illustratively has flats 808 (only one of which is identified in FIG. 8 with the reference number 808) in its inner surface 810 to which the flat magnets 802 are mounted. Outer surface 812 of the stator housing 806 illustratively is arcuate except for two opposed flats 814 centrally located over the center flat magnet 802 of the flat magnets 802 for the poles 804. These two opposed flats 814 extend across the respective center flat magnet 802 of the respective pole 804 and partially across each of the two flat magnets 802 adjacent opposed sides of each center flat magnet 802. As such, the thickness of the stator housing 806 is thinner adjacent the center flat magnets 802 of each pole 804 and thicker adjacent the outer flat magnets 802 of each pole 804. This provides the increased flux density at the outer flat magnets 802 where it is most needed and yet allows for reduction in the thickness of steel (saving both weight and material) at the center flat magnets 802 where having such increased flux density is less important.

In an aspect, the flat magnets are illustratively overmolded with an overmolding to secure them in place in the stator housing (not shown in FIG. 8), such as the overmolding discussed in U.S. Pat. Nos. 6,983,529 and 7,088,024. The stator housing 806 may illustratively include a notch 816 that, in cooperation with the flats 814 in the outer surface 812 of the stator housing 806, prevent the stator housing 806 from rotating in the power tool housing, such as disclosed in the application titled “Anchoring System for a Stator Housing Assembly Having an Overmolding” (application Ser. No. 12/443,196; Publication No. 2010/0013336), the entire disclosure of which is incorporated herein by reference. The notch 816 may be molded as part of the magnet overmold process. Alternatively, the notch 816 may be machined, stamped, etc.

In an aspect of this disclosure, and with reference to FIG. 9, magnets 900 are assembled into stator housing 902 of stator assembly 904 outermost to innermost. In FIG. 9 where there are five magnets, outermost magnets 900 (designated with reference number 906) are first inserted into stator housing 902, then the next outermost magnets 900 (designated with reference number 908) then the center magnet 900 (designated with the reference number 910). While magnets 900 are shown as flat in FIG. 9, it should be understood that this assembly order can be used with arcuate magnets.

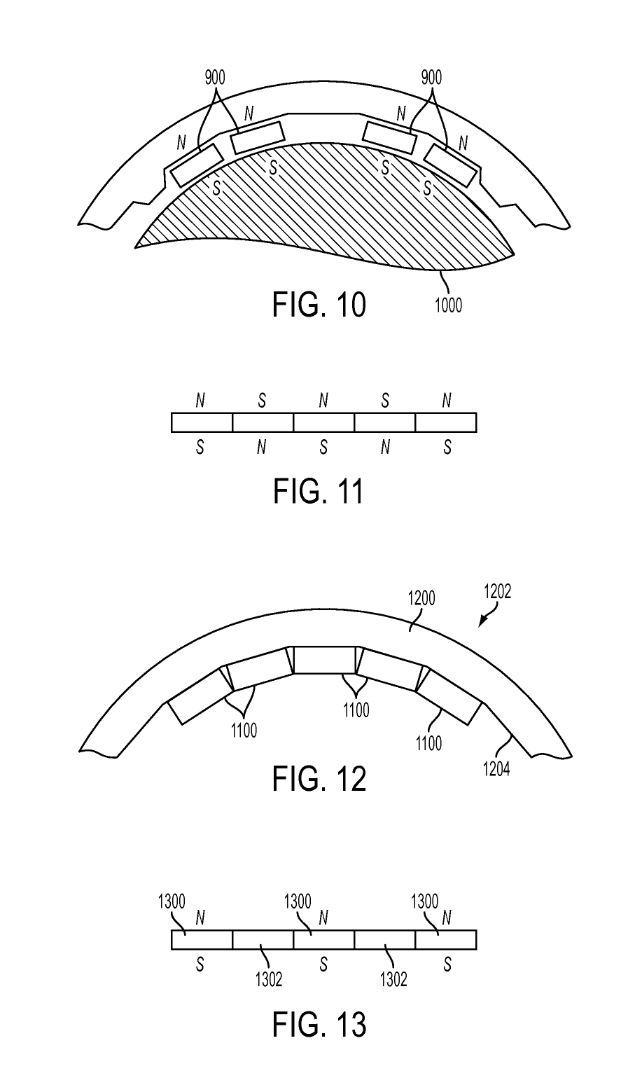

In carrying out the outermost to innermost assembly of magnets 900, the outer magnets 906, 908 which have already been inserted in stator housing 902 can advantageously be held in place with a non-magnetic fixture (FIG. 10) when center magnets 910 are inserted in stator housing 902. In an aspect, a guiding fixture is used when inserting center magnets 910 in stator housing 902 to keep center magnets 910 from jumping on top of the already positioned outer magnets 906, 908 (which is the magnetically stable position).

Alternatively, magnets 900 could be assembled into stator housing 902 innermost to outermost.

In an aspect of this disclosure, it may be optimal to have a magnetic circuit with edges of adjacent flat magnets touching at their mating edges, or it may be optimal to have a slight space between the flat magnets depending on the optimization of the magnet circuit.

In accordance with a variation of the assembly sequence described above where the magnets are inserted into the stator housing from outermost to inner most, magnetized magnets having the same magnetic polarity orientation are assembled in a stator housing or, alternatively, the flux ring, having recesses or protruding anchors. Details of such embodiments are disclosed in the parent application Ser. No. 12/443,191 (Patent Publication No. 2010/0033036), which is incorporated herein by reference in its entirety.

In an aspect of this disclosure, the magnets are pre-magnetized (partially or completely) before assembling them into the stator housing. In an aspect of this disclosure, and with reference to FIG. 11, the magnets 1100 are pre-assembled with alternating magnetic polarities: N-S-N-S. In this regard, the poles of the magnets 1100 are radially oriented where one of the North and South poles of each magnet 1100 is on a radial outer edge of the magnet 1100 and the other is on a radial inner edge of the magnet 1100. By alternating polarities, the magnets 1100 that form each pole of the motor attract each other at their adjacent edges. Once the magnets 1100 are pre-assembled, they are then inserted into stator housing 1200 (FIG. 12) to form stator assembly 1202 (only a portion of which is shown in FIG. 12). The magnets are then re-magnetized to a final, desired magnetic polarity configuration. Typically, the final, desired magnetic polarity configuration would have each magnet of a pole with the same magnetic polarity as the other magnets of the pole.

In an aspect, since such an alternating polarity pattern is not the required final magnetic configuration, the magnets 1100 are only partially magnetized during the pre-assembly stage. This allows for easier re-magnetization in the final desired magnetic polarity configuration.

In an aspect, the stator assembly having the magnets 1100 pre-assembled with alternating magnetic polarities is pre-heated to an appropriate elevated temperature to more easily fully re-magnetize the magnets 1100 in the final, correct polarity magnetic configuration.

Before the preassembled magnets 1100 are inserted into stator housing 1200, the edges of the adjacent magnets are touching. Upon insertion into an a stator housing having a generally arcuate inner surface, such as stator housing 1200, the edges of magnets 1100 become separated and conform to the more magnetically stable condition of the generally arcuate shape of the inner surface 1204 of stator housing 1200. At this point, the edges of adjacent magnets 1100 remain touching only by line contact at their radially inner edges. If it were then necessary to separate the magnets in the final magnetic configuration, it would be difficult in that the magnetic attraction between the adjacent magnets would need to be overcome. As a practical matter, this would likely require separations or spacers, which adds parts and increases cost. It should be understood that the generally arcuate shape of inner surface 1204 of stator housing 1200 can include flat sections on which the magnets 1100 are placed.

In an aspect, alternatively to pre-assembling the magnets in an alternating magnetic polarity arrangement, the magnets are pre-assembled with alternating magnetized (at least partially) magnets and unmagnetized magnets. (As used herein, an “unmagnetized” magnet is a block of magnetic material formed to the desired shape but not magnetized and a “magnetized” magnet is a block of magnetic material formed to the desired shape and magnetized.) In this aspect, as shown in FIG. 13, magnetized magnets 1300 are oriented with the same polarity orientation with unmagnetized magnets 1302 interspersed between magnetized magnets 1300. The unmagnetized magnets 1302 bridge and hold together the magnetized magnets 1300. The aforementioned assembly considerations also apply to this approach, but it is easier to fully magnetize the pre-assembly as there is no need to reverse the polarity of any of the magnets. That is, the magnetized magnets 1300 are pre-assembled in the final polarity orientation and when magnetizing the magnets to the final desired polarity configuration, there is no need to reverse the polarity of the unmagnetized magnets 1302.

Where it is desired to have a slight space between adjacent magnets of a pole (or a pole segment where the pole has multiple segments each having multiple magnets), then in an aspect unmagnetized magnets are inserted into the stator housing and then magnetized after they are affixed the magnets to the stator housing. Alternatively, the magnets are magnetized and then inserted into the stator housing (and affixed thereto) with all the magnets having the same magnetic polarity orientation, which is the same magnetic polarity orientation as the final correct polarity orientation. No further magnetization of the magnets would thus be needed after they are inserted into the stator housing. Since the adjacent magnets have the same polarity orientation, they repel each other causing them to be spaced apart from each other within the boundaries of the physical restraints on the outer most magnets.

In an aspect, the magnets can be secured in the stator housing by glue, overmolding, double sided adhesives, or other affixation techniques, with or without being magnetized before they are inserted in the stator housing. Where the magnets are unmagnetized magnets, fixturing would illustratively be used to properly position the magnets in the stator housing.

It should be understood that while many of the above aspects were described with reference to a two pole motor (i.e., one North and one South pole), these aspects are also applicable to motors having more than two poles.

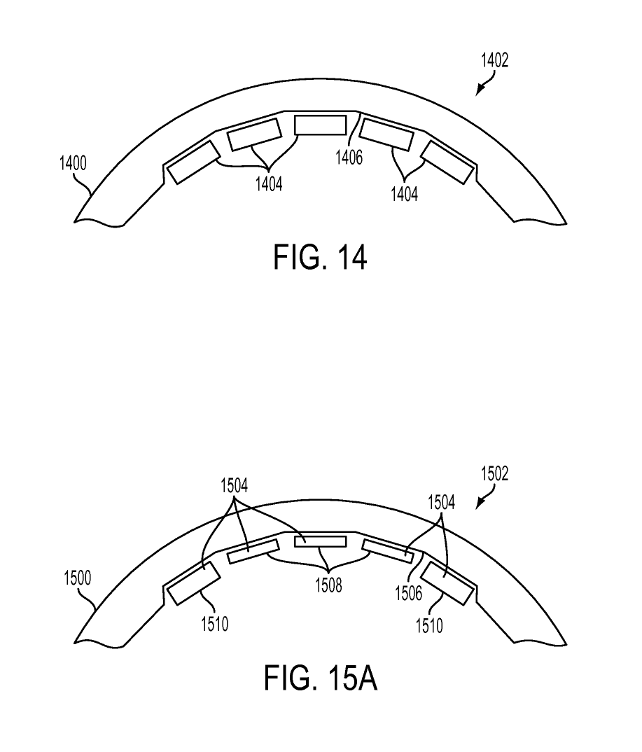

In another aspect, with reference to FIG. 14 which shows a section of a stator housing 1400 having a pole 1402, permanent magnets 1404 are affixed to an inner surface 1406 of stator housing 1400. Permanent magnets 1404 are unevenly spaced about pole 1402 to further optimize motor performance. Permanent magnets 1404 can be either flat permanent magnets or arcuate permanent magnets.

According to aspects of the invention, magnets in the stator assembly may have different characteristics depending on their position in the stator assembly. Having magnets of similar shape and characteristics surely simplifies the manufacturing process. There are advantages, however, to selecting magnets of different shapes, grades, or material based on the position of the magnet in the stator assembly. By optimizing the magnet's placement and properties, cost and performance synergies can be realized. For example, by using larger magnets or magnets of higher magnetic grade near the ends of the magnetic poles, the magnets can be utilized in a cost-effective manner without compromising performance.

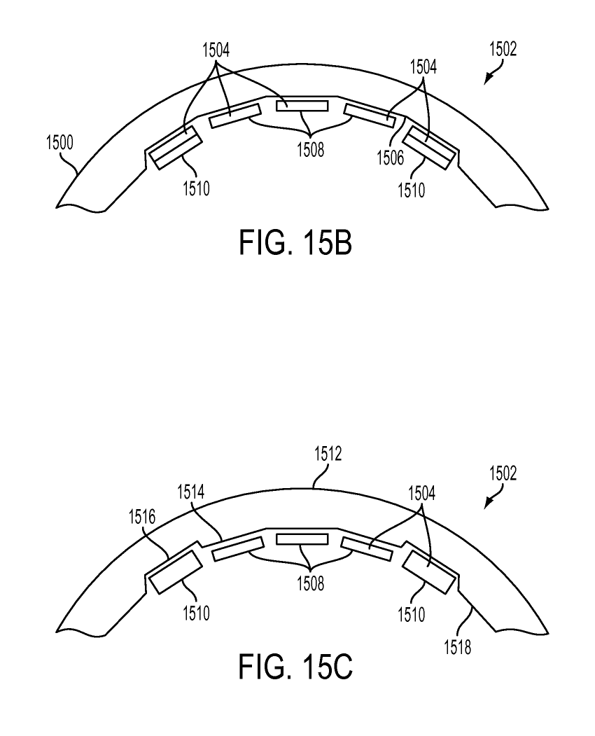

In an aspect, with reference to FIG. 15A, which shows a section of a stator housing 1500 having a pole 1502, permanent magnets 1504 are affixed to an inner surface 1506 of stator housing 1500. The three inner most permanent magnets 1504, designated with reference number 1508, are thinner than the outermost permanent magnets 1504, designated with reference number 1510. Permanent magnets 1504 can either be flat permanent magnets or arcuate permanent magnets. In an embodiment, the innermost permanent magnets 1508 are at least ten percent thinner than the outermost permanent magnets 1510. Thicker magnets provide a higher level of demagnetization resistance. Therefore, the outermost magnets provide a higher demagnetization resistance at the ends of the poles within the stator housing 1500 where demagnetization is more likely to occur. The innermost permanent magnets 1508 and the outermost permanent magnets 1510 may be of the same of different grades of magnetic material. This arrangement saves cost by reducing the total amount of magnetic material used while optimizing the distribution of magnetic energy within each pole.

In an embodiment, in order to ease the manufacturing process, permanent magnets of the same size may be provided and the thicker outermost permanent magnets 1510 may be obtained by stacking two or more permanent magnets together of equal thickness together, as shown in FIG. 15B.

The above embodiments may be implemented in a stator a 1512 according to the exemplary embodiment shown in FIG. 15C. In this embodiment, in order to keep the inner surfaces of the magnets 1508, 1510 along the same radius from the center of the stator housing 1512, the outermost permanent magnets 1510 are placed within a recess 1516 and the inner permanent magnets 1508 are placed on a projected surface 1514 inside the recess 1516. In an embodiment, the inner surfaces of the permanent magnets 1508, 1510 may be aligned with the inner surface 1518 of the stator housing 1512.

According to another aspect, permanent magnets may also be optimized based on the positioning of the magnets of different magnetic grade, i.e., different demagnetization resistances. The grades of the magnet refer to the composition of the magnet and are typically denoted by industry-standard identifier such as “EH”, “SH”, “M”, etc., although different identifiers may be used depending on the manufacturer. For example, permanent magnets often denoted as “EH” magnets have a higher composition of rare earth elements. “EH” magnets typically contain about 21% neodymium (Nd), which provides them with high level of flux density, and 9% dysprosium (Dy) and/or terbium (Tb) (or combination of both), which provides them with a high level of demagnetization resistance. Since Dy and Tb are the more expensive of rare-earth material, however, it is advantageous to reduce the amount of EH magnets used within the stator housing. Magnets denoted as “M” magnets have a lower composition of rare earth elements have a lower demagnetization resistance. “M” magnets typically include 33% Nd, but do not include any Dy or Tb. Accordingly, M magnets do not have a high level of demagnetization resistance. Magnets denoted by “SH” refer to those having a mid-range demagnetization resistance and may include, for example, 28% Nd and 4% Dy and/or Tb (or combination of both). Since Dy and Tb rare earth materials are more expensive then other types of magnetic material, M magnets are less expensive than SH magnets, which are in turn less expensive than EH magnets.

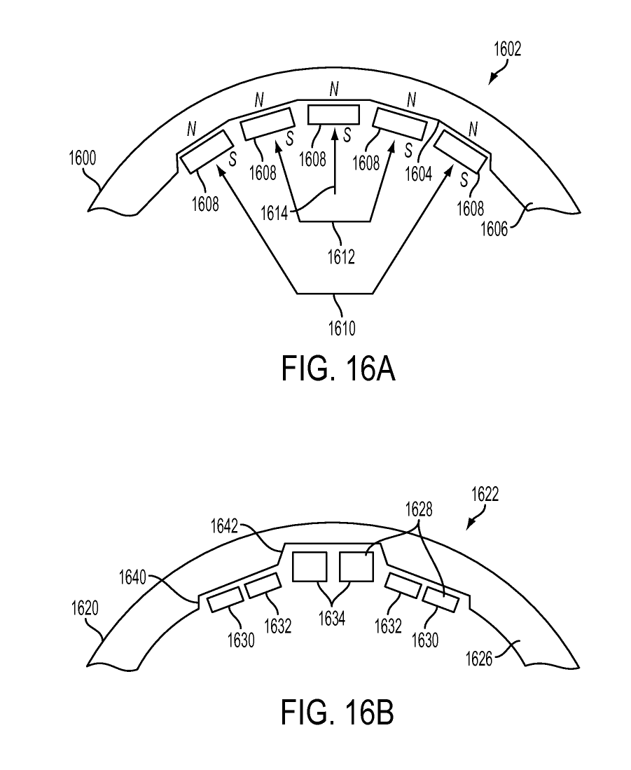

Referring FIG. 16A, according to an embodiment, the stator assembly 1600 includes a pole 1602 and permanent magnets 1608 having different demagnetization resistance properties are affixed to the inner surface of the stator housing 1600. The permanent magnets 1608 are located within the recess 1604 in the inner surface 1606 of the stator housing 1600. The flat magnets in this embodiment have different grades of demagnetization resistance depending on their respective location within the pole 1602. For example, magnets 1610 arranged at the ends of the pole 1602 have the highest demagnetization resistance (e.g., “EH” grade), magnets 1614 in the middle of the pole 1602 have a relatively low demagnetization resistance (e.g., “M” grade), and magnets 1612 therebetween have a mid-range demagnetization resistance (e.g., “SH” grade). This arrangement allows for a more cost-effective distribution of magnets without compromising the overall motor performance.

While the example above is illustrated using flat magnets, it is envisioned that arcuate magnets having different demagnetization resistance properties may similarly be utilized. Also, while the illustrated magnets are spaced-apart, it is envisioned that some embodiments of this invention may utilize magnets that are not spaced-apart via any gaps.

Since it is often difficult to differentiate between identically-shaped magnets of different demagnetization resistance grade, according to an exemplary embodiment, magnets with different grades may be provided with different shapes and/or sizes to allow for robust assembly fixtures. Alternatively, different grade magnets may be provided with different magnetization levels. For example, magnets of a particular grade may be fully or partially pre-magnetized while magnets of a different grade may be pre-magnetized to a lesser degree or not be pre-magnetized at all. In yet another embodiment, different grade magnets may be provided with different colors using, for example, Nicole plating or coating higher grade magnets.

In an alternative embodiment according to FIG. 16B, magnets of different grades may be used with different widths based on their respective positions within the magnetic pole. As shown in FIG. 16B, the stator assembly 1620 includes a pole 1622 and permanent magnets 1628 having different demagnetization resistance properties and affixed to the inner surface of the stator housing 1620. Outer permanent magnets 1630 and 1632, which are made of higher grade rare-earth magnetic materials, have a relatively smaller thickness and are arranged within the first recess 1640 of the inner surface 1626 of the stator housing 1620. In this example, the permanent magnets 1630 may be EH or SH magnets and permanent magnets 1632 may be SH magnets. The inner permanent magnets 1634, which are made of lower grade magnetic material such as M magnets, have a relatively greater thickness and are arranged within the second recess 1642. This allows for a more effective utilization of the more expensive high grade magnets at the pole ends without comprising performance in the middle portion of the pole 1622.

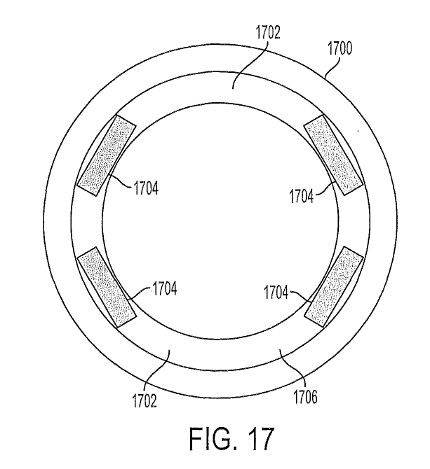

FIG. 17 depicts yet another embodiment of this disclosure. According to this embodiment, the stator assembly 1700 includes two poles 1702, each pole including segments of sintered, high performance magnets 1704 such as Neodymium-Iron-Boron (NdFeB) or other rare-earth material magnets are utilized as pole tips. The magnets segments 1704 are over-molded with isotropic or antistropic injection-bonded magnetic material 1706. The injected-bonded magnetic material 1706 may be, for example, magnetic powder material mixed into a plastic resin. The magnetic powder material may be made of rare-earth metal material such as neodymium, or non-rare-earth material such as ferrite or alnico material. The over-mold of magnetic material may be performed using methods disclosed in, for example, U.S. Pat. Nos. 6,983,529 and 7,088,024, which are incorporated herein by reference in their entirety. The over-mold process of the plastic material may be performed such that a higher concentration of magnetic material is present in the areas near the poles 1702, particularly between the magnet segments 1704 within each pole 1702.

The presence of the injected-bonded magnetic material 1706 provides the benefit of added protection for the magnets 1704 as well as supplemental magnetic flux for the poles 1702. Overmolding also provides the advantage of improving corrosion resistance of magnets, especially for NdFeB magnets, which are prone to corrosion. Overmolding also allows for use of alternative magnet grades or coatings that are less expensive. Overmolding further provides a method of discrete magnet retention that lessens the dependency on the quality of the magnet gluing process or the quality of the magnet coating process.

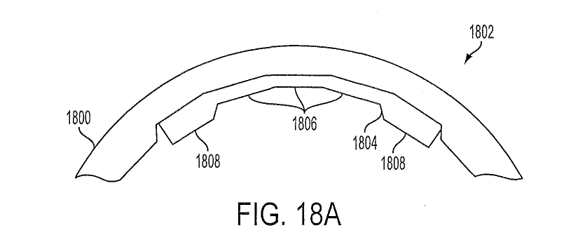

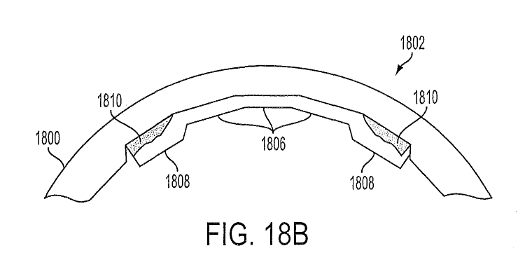

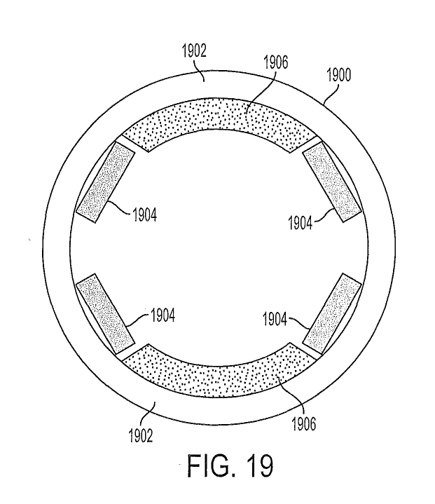

In another embodiment, as shown in FIG. 18A, instead of using magnet segments over-molded with magnetic material, a single layer of over-mold magnetic material 1804 may be used for each pole 1802 of the stator assembly 1800. The over-mold layer 1804 may include rare-earth magnet powder mixed in plastic resin or similar material and over-molded over the pole 1802 of the stator assembly 1800. The over-mold layer 1804 may include a recessed region 1806 in the middle of the pole 1802 and two relatively thicker regions 1808 at the pole tips. The pole tip regions 1808 may be at least twice at thick as the middle portion of the recessed region 1806. In an embodiment, the recessed region 1806 may become gradually thicker near the pole tip regions 1808. The over-mold layer 1804 may be injection-bonded to have varying thickness levels.

The overmold layer 1804 may be provided in a recess within the stator assembly 1800. According to an embodiment, the stator assembly 1800 may be thicker behind the middle portions 1806 than at the pole tips 1808, such that inner surface of the overmold layer 1804 facing the center of the stator assembly 1800 is uniformly aligned at the same distance from the center of the stator assembly 1800.

Alternatively or in addition, as shown in FIG. 18B, different grades of demagnetization resistance may be achieved using a two step process. In this embodiment, a first shot of magnetic material 1810 is planted over the pole ends and a second shot of over-mold material is laid over the inner surface of the pole 1802 and the magnetic material 1810. The magnetic material 1810 may be made of rare-earth magnetic material or other material of higher magnetic grade, thus providing a higher level of demagnetization resistance at the pole ends. Once again, the stator assembly 1800 may include a projection (not shown) behind the middle portions 1806, such that inner surface of the overmold layer 1804 facing the center of the stator assembly 1800 is uniformly aligned at the same distance from the center of the stator assembly 1800.

According to another embodiment, as shown in FIG. 19, each pole 1902 of the stator assembly 1900 includes a pair of segments of sintered, high performance magnets 1904 such as NdFeB or other rare earth magnets are utilized as pole tips. In this embodiment, instead of using injection-bonded rare-earth magnetic material between pole tips, a lower-grade and lower-cost non-rare-earth (e.g., ferrite or alnico) magnet segment 1906 is arranged between the two magnets 1904 of each pole 1902. The ferrite magnet segment 1806 may include one or more curved or flat magnets.

The description of the invention is merely exemplary in nature and, thus, variations that do not depart from the gist of the invention are intended to be within the scope of the invention. Such variations are not to be regarded as a departure from the scope of the invention.

What is claimed is:

1. A power tool, comprising:
a housing;
a permanent magnet electric motor in the housing, the electric motor including a rotor and a stator, the stator having a stator housing with at least a North pole and a South pole, each pole including a plurality of permanent magnets of the same polarity including two outer magnets arranged at pole tips and at least one inner magnet disposed therebetween, wherein the magnets are affixed to an inner surface of the stator housing, the outer magnets have greater thickness than the inner magnet to provide higher demagnetization resistance than the at least one inner magnet within each pole, and the inner surface of the stator housing including a projected surface within each pole to which the inner magnet is affixed so that surfaces of the inner and outer magnets facing a center of the stator housing are arranged at a same distance from the center of the stator housing; and
an output member coupled to the electric motor.

2. The power tool of claim 1, wherein the outer magnets are at least ten percent (10%) thicker than the inner magnet.

3. The power tool of claim 1, wherein the inner and outer magnets comprise substantially similar magnetic material.

4. The power tool of claim 1, wherein the inner surface of the stator housing includes a recessed surface at each pole within which the inner and outer permanent magnets are arranged within each pole, and the projected surface is arranged within the recessed surface.

5. The power tool of claim 1, wherein the plurality of permanent magnets comprise rare earth magnetic material.

6. The power tool of claim 1, wherein the plurality of permanent magnets are flat magnets.

7. The power tool of claim 1, wherein the outer magnets each include at least two magnets stacked on top of one another.

8. A permanent magnet electric motor, comprising:
a stator having a stator housing with at least a North pole and a South pole, each pole including a plurality of permanent magnets of the same polarity including two outer magnets arranged at pole tips and at least one inner magnet disposed therebetween, wherein the magnets are affixed to an inner surface of the stator housing, the outer magnets have greater thickness than the inner magnet to provide higher demagnetization resistance than the at least one inner magnet within each pole, and the inner surface of the stator housing including a projected surface within each pole to which the inner magnet is affixed so that surfaces of the inner and outer magnets facing a center of the stator housing are arranged at a same distance from the center of the stator housing; and
a rotor rotatably disposed within the stator.

9. The electric motor of claim 8, wherein the outer magnets are at least ten percent (10%) thicker than the inner magnet.

10. The electric motor of claim 8, wherein the inner and outer magnets comprise substantially similar magnetic material.

11. The electric motor of claim 8, wherein the inner surface of the stator housing includes a recessed surface at each pole within which the inner and outer permanent magnets are arranged within each pole, and the projected surface is arranged within the recessed surface.

12. The electric motor of claim 8, wherein the plurality of permanent magnets comprise rare earth magnetic material.

13. The electric motor of claim 8, wherein the plurality of permanent magnets are flat magnets.

14. The electric motor of claim 8, wherein the outer magnets each include at least two magnets stacked on top of one another.
